(19) United States
(12) Patent Application Publication
(10) Pub. No.: US 2008/0300790 A1
(43) Pub. Date: Dec. 4, 2008

(54) Environmental data delivery - edd

(76) Inventor: James Kirunda Kakaire, Binghamton, NY (US)

Correspondence Address: James Kakaire, P.O. Box 361, Norwich, NY, 13815, US

(21) Appl. No.: 11/807,780

(22) Filed: May 29, 2007

(51) Int. Cl. G01W 1/02

(52) U.S. Cl. 702/3

(57) ABSTRACT

Apparatus is designed to collect environmental data on land and sea and wirelessly transmit via satellite or cell towers. This allows for instantaneous analysis to show how oceans warm. An application predicts hurricanes and tornadoes, and precisely tells where tornadoes are to strike and path thereafter. In addition, data locates areas to use to reduce or eradicate hurricanes and tornadoes.

Data variables includes atmospheric temperature, water temperature at multiple depths, pressure, wind speed, wind direction, humidity and geometric coordinates of location in relation to time and latitudinal position of the sun to determine rates of heat transmission from earth's solids such as deserts, deforested land, concrete, rocks and beaches to water bodies.

Specific heat capacities shows how heat radiated from the sun is transmitted to water bodies, how deforested lands in the tropics accounts for extra warmth in the oceans lately, and how warm water moves to the poles.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

This system is primarily designed to study how oceans gain temperature, rate at which they warm and how that can be reversed. It is also meant to study formation of both water based storms and land based storms and how storms can be reduced or eliminated.

It relates to real time environmental data collection, ocean warming, sea level elevation, Formation and Behavior of both land and water based storms.

### ADVANTAGES OF THE INVENTION

Apparatus is used to study water based storms, land based storms and warming of water bodies in general by providing instantaneous data that helps to prove the hypotheses stated in this application.

Apparatus proves that ocean water slowly gains heat effective tropic of Capricorn as it travels north along with the sun as the sun travels towards the tropic of Cancer. It also shows that water collects heat from earth solids under which the sun is overhead as the sun moves southwards from Cancer to Capricorn

In the apparatus, we also see that it is this slow movement of the warmed water and double heating from the equatorial region that makes hurricanes last until late in the year for the Atlantic ocean.

Data determines whether atmospheric pressure is always directly or inversely proportional to atmospheric temperature due to sun rays given other factors on land such as deserts, exposed lands, rocks, concrete, beaches and forests.

Using data from this device enables determination of relationships between water temperatures, atmospheric temperature and land temperature each month of the year in relation to latitudinal position of the sun

Device enables determination of relationships between surface temperature, atmospheric pressure, wind speed wind direction and humidity

Device enables determination of relationships between surface temperature, water temperature, wind and water movement (direction/speed/volume) which helps with analysis of storms such as hurricanes and typhoons.

Water based device is expected to be moved by water. This movement is in the direction of ocean water in relation to position of the sun (in terms of date/month), temperature and pressure.

Device helps to find speed of ocean water in relation to speed of sunrays as the sun rays move between the tropic of Capricorn and tropic of Cancer. It takes the sun rays about six months from Capricorn to Cancer and vise versa but it takes slightly longer for the water to move from tropic to tropic because water reaches the north and south poles where intense sun doesn't reach.

Data helps find effects of trees on temperature and pressure.

Determines paths of both water and land based storms.

Apparatus eliminates the need for human storm chasers in case of storms such as tornadoes. Device tells actual area where land based storms forms and direction they are to take thereafter whether at night or during daytime.

Apparatus leads to elimination of hurricanes or reduction of hurricane category to minimal by identifying areas that needs forestation in the tropics. Creating forest reserves in those areas cools regions of interest and prevents ocean water from warming fast. This happens because the heat energy directed to vegetation leads to evapotranspiration which cycles into rain or dew and cools the earth solids. Cooling earth solids prevents those solids from sending heat to oceans hence preventing water storms. On the other hand, lands exposed due to deforestation, rocks, concrete, beaches and deserts warm oceans and leads to storms.

Availability of data from several places both on land and at sea gives representative samples of the globe which leads to more accurate readings and hence better conclusions.

Data is readily available in real time from many different places. Where there is no access to satellite or internet, internal memory or removal memory provides data to weather stations.

Land based devices are placed in different environments. To determine effects of forests on temperature and pressure, or effects of any other solids such as deserts, bare lands, beaches, rocks etc, devices are placed in forests, near forests, in grasslands, on bare lands by rocks, by city concrete etc. Latitudes, Time (Month/Date) and altitudes are put into consideration when placing the devices since everything is dependent on the sun's energy and when the sun gets to certain latitudes.

Apparatus provides ocean temperatures at multiple depths at the same vertical axis while providing other parameters that with water temperatures gives details of water based storms and ocean/lake warming.

Apparatus provides data in real time for a prolonged period enabling analysis of a big regions at the same time.

Apparatus tells specifics of land based storms such as tornadoes before they form hence preventing twisters from taking people unaware at night and leading into deaths.

Land storms are categorized using wind information and other factors favorable for twister formation and impact is estimated at that point other than categorizing actual storms after striking.

Most of the winds travel long distances before they come to a point where they form twisters. Using data from apparatus, one determines origin of winds and how the winds progress. Using that information, the winds can be intercepted before they gain high momentum by planting wind breakers in know regular paths at give distances apart.

### SUMMERY OF THE INVENTION

Basing on the physics, geography and chemistry of the earth in relation to the sun, this system uses information technology and engineering to allow detailed study of how water bodies gain temperature, water based storms and land based storms. System shows how oceans gain heat and leads to reversal of ocean warming. A device is used to collect multiple data variables including atmospheric temperature, water temperature at multiple depths on the same axis, atmospheric pressure, wind speed, wind direction, humidity and coordinates of the location of the device to permit analysis of forces of nature in water bodies and land.

The device transmits collected data in real time via means such as satellite and internet instantaneously to a data collection location.

Using collected data, analysts find relationships between two or more of the parameters temperature, pressure, wind speed, wind direction, and humidity in relation to a specified location and latitudinal position of the sun.

Using specific heat capacities of the earth's elements (water, vegetation and solids), the rate of heat transmission from solids to large water bodies is determined by the bell experiment (reference [051]).

The system provides actual areas where land storms such as tornadoes are to form, when they are to form and specific direction tornadoes are to take after formation. It provides information that allows evacuation from paths of tornadoes hence preventing deaths. System also eliminates need for human storm chasers since it can predict land storms and their paths before the storms form. System shows effects of temperature on pressure, effects of temperature and pressure on storm formation and movement, and effects of trees, deserts, exposed land, rocks, concrete and beaches, on temperature/pressure.

System leads to reduction of category of water storms reaching land, or total elimination of the storms by providing data that allows intercepting of the storms before the storms form.

### BRIEF DESCRIPTION OF THE DRAWINGS

A complete understanding of the present invention may be obtained by reference to the accompanying drawings, when taken in conjunction with the detailed description thereof in which:

FIG. 1 shows all steps of physical (viewable hardware) data collection which includes the data collecting/transmitting device, satellite, intermediary receiver, data receiving servers, intermediary data analysis severs, reporting servers and end user devices such as computers used by weather experts. However, shape or size of these devices is irrelevant. Consumer electronic devices such as computers and cell phones are connected to reporting servers to provide storm information directly to consumers at any time of day.

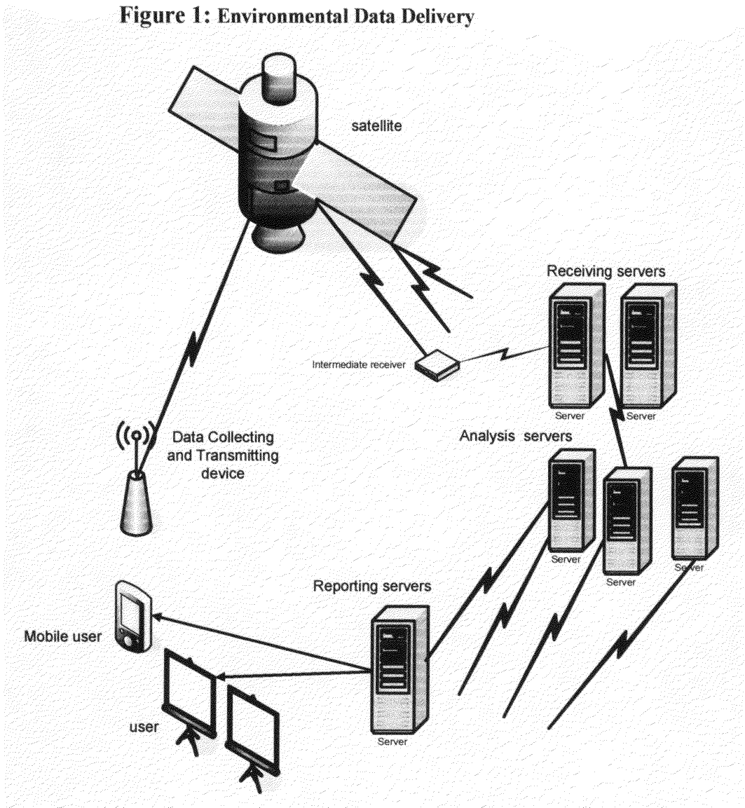

FIG. 2 shows viewable details of a water based data collector/transmitter with a weight at the bottom to keep it upright in a 3 dimensional plane and thermometers at various depths to determine heat absorption rates at different depths. Not showed are the instruments for collecting surface temperature, atmospheric pressure, wind speed, wind direction and humidity. A thermometer, barometer, anemometer, wind vane and a hygrometer may be used respectively but other instruments of choice that converts data into a format for easy transmission may be built into device.

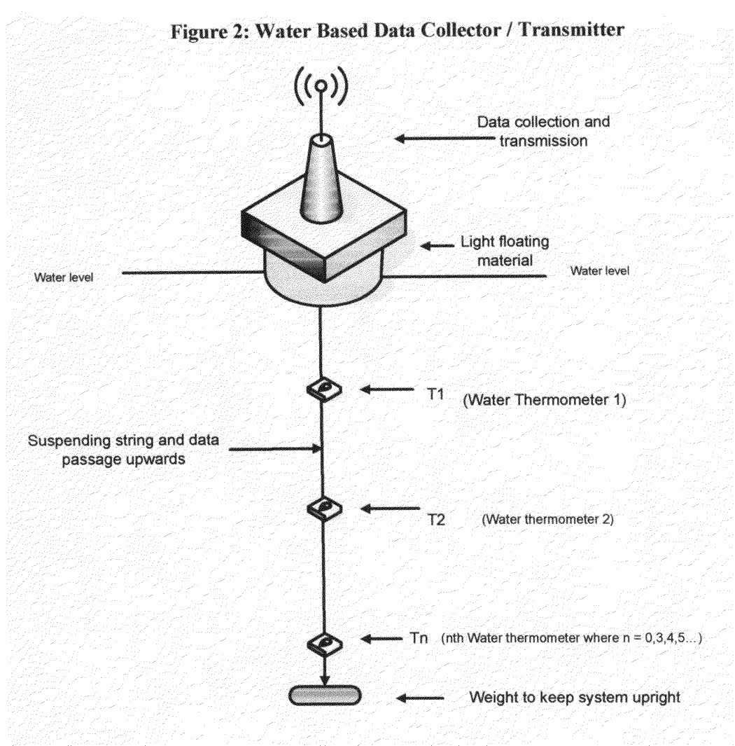

FIG. 3 shows land based data collectors. Category A is like FIG. 2. That is, transmits data to satellite or wireless internet but with no water thermometers. Category B is meant for direct connection to wired or unwired internet to deliver data to servers via the Internet and Category C is meant for manual data retrieval in places where internet is not available and satellite services are not feasible.

FIG. 4 shows layout of devices equidistant to each other either on land or in water but distance may be adjusted as needed. These devices operate in groups under one software application in order to feed the application with data from each location. Each device can be a member of 2,3 or more groups as an intersecting member (as in sets In mathematics) but operates independently. This gives the application ability to work like a tool called a linked list in computer programming. Each node in a linked list stores address of the previous node. However, in this application, malfunctioning devices don't affect performance of the application since devices don't depend on each other (FIG. 5). For the land version, these devices may be designed to listen to each other and provide each other with data.

FIG. 5 shows logic flow chart of the application collecting data. While devices continually broadcast data packets, the application connects, captures data packets and disconnects from a device. It connects to the next device until all devices in the group are done writing to the server. Receiving servers then synchronize data with analysis servers and the process repeats again. While receiving servers are receiving, analysis servers sends data to reporting servers as scheduled.

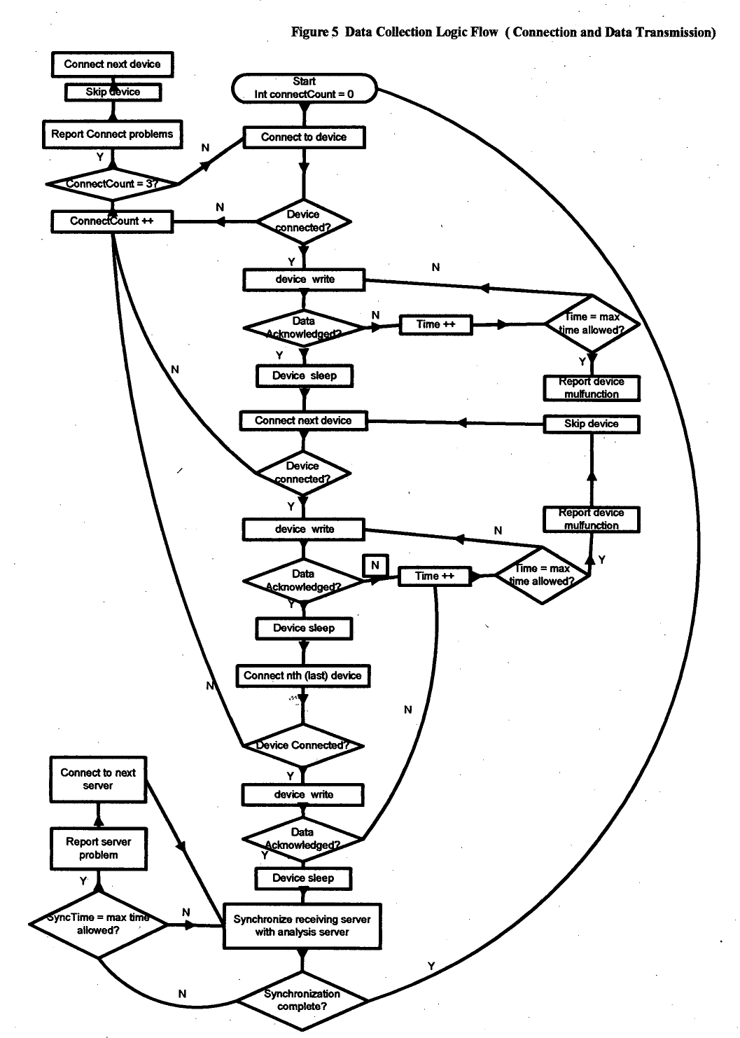

FIG. 6 is logic flow of land storm tracking for storms such as tornadoes.

FIG. 7 shows how data from a water based device may be stored on a server.

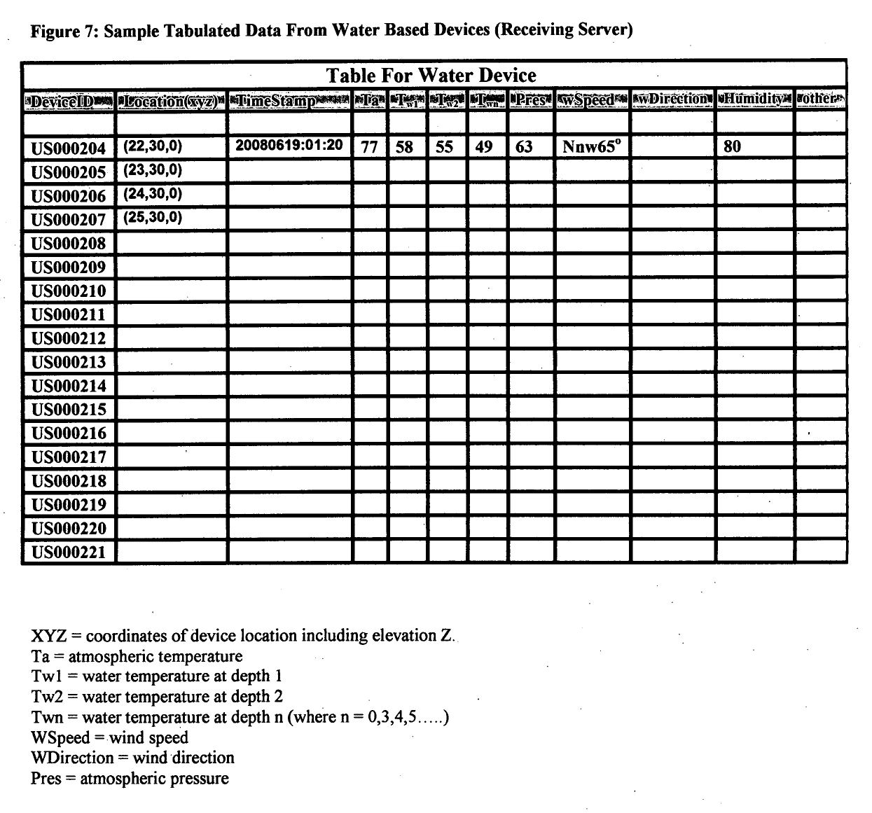

FIG. 8 shows how data from a land based device may be internally stored on a server

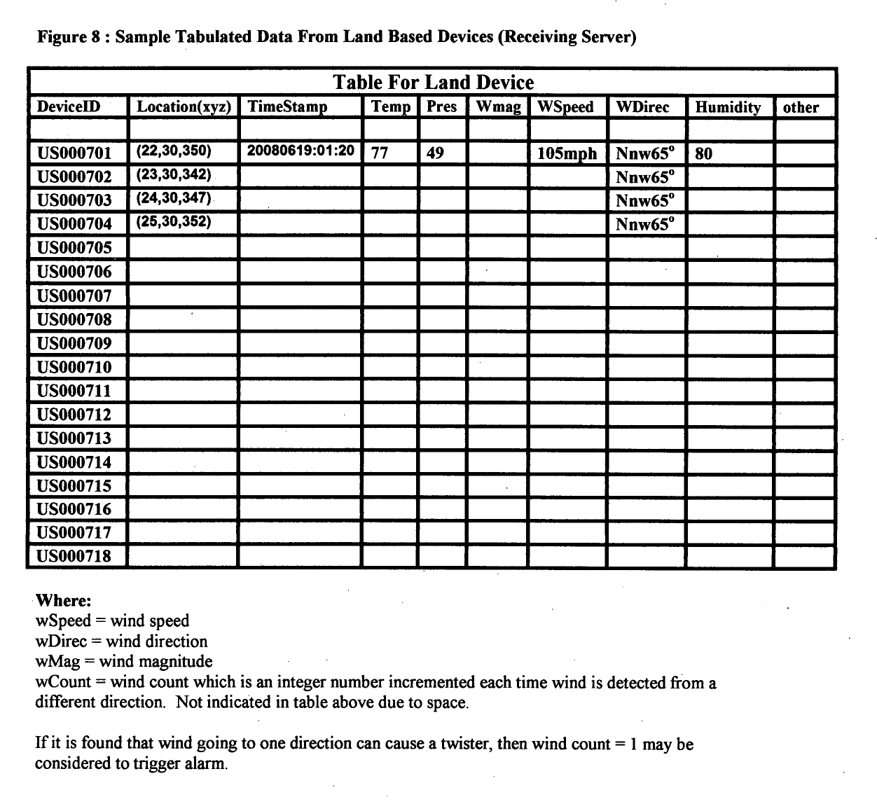

FIG. 9 shows how temperature readings can be obtained from an existing database after device has collected data or readings from device directly to determine daily temperatures (highest and lowest) which in turn can be used to get monthly and annual highs and lows

FIG. 10 shows graph of data from several locations along a given latitude starting from the inner most (inland) location to a coastal location when the sun is overhead. This shows how heat travels from the inner solids towards water bodies at a given time of the year. Time is a factor here because major heat transfer occurs when the sun is overhead latitudes of an exposed area.

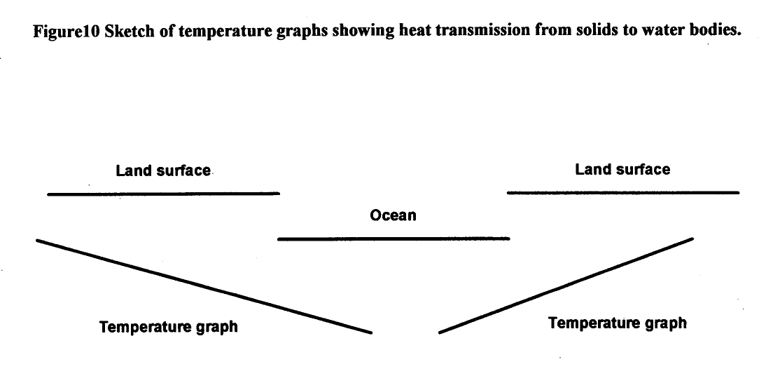

This figure covers the bell experiment (reference [051]). In this experiment, one can assume the Atlantic ocean (the narrowest ocean) or any ocean to be a humongous laboratory apparatus. Collecting data in finite increments of latitudinal distance following movement of sunrays as they are overhead particular latitudes northwards (December through June) then southwards (June through December) or vise versa, one gets uniform results that conforms to the laws of thermodynamics. Deviations from expected results (Atlantic region) are only found on the western land block of the Atlantic between roughly 12 degrees north (Venezuela) and approximately 37 degrees north (South-North/Carolina).

### DETAILED DESCRIPTION OF PREFERRED EMBODIMENT

Specific Heat Capacity: The quantity of heat energy required to raise the temperature of a given mass of a substance by some amount varies with the substance.

The heat required to raise the temperature of 1 kg of water by 1 degree Centigrade is about 4186 Joules per kg degrees centigrade but the heat required to raise temperature of 1 kg of most solids is less than 1800 Joules.

By specific heat capacity, we see that solids including ice, absorbs heat much quicker than water. That is why water surfaces in large water bodies is always colder than surrounding solids during day time when the sun is heating.

How Oceans/water bodies warm: When 2 objects at different temperatures are physically connected no matter what their texture is, heat energy travels from one at a higher temperature to the other.

Heat keeps traveling in that direction until a thermal equilibrium is established. In the case of the earth (solids) and Oceans or lakes (water bodies), it is an irreversible process because a thermal equilibrium can not be established due to size of the oceans so heat travels only in one direction. By the 2^{nd} law of thermodynamics, we know that change in entropy for a system plus it's surroundings is always positive for an irreversible process. This implies that heat gain for the water bodies will always be positive due to the relatively high specific heat capacity (reference [037]) of water that keeps it cooler than the surroundings.

When the sun heats the earth during daytime, it creates a semi-closed system that allows some heat upwards through evaporation of water bodies and evapotranspiration of vegetation. Deserts, lands exposed by deforestation, rocks, concrete and beaches reflect minimal amount of heat to the atmosphere since heat from the sun downwards, may be at a higher temperature than the heat that would be reflected to the atmosphere. The heat absorbed by these solids/powders is then forced to move towards water bodies which are always at lower temperatures.

Since water has a much higher specific heat capacity than desert sand, exposed land due to deforestation, rocks, concrete and beaches, it stays at a lower temperature during the heating process so it absorbs heat energy from these solids and try to establish a thermal equilibrium. The equilibrium can't be reached because oceans are so huge so they continuously gain heat. Since water travels north and south depending on time of the year (sun driven), the heat is carried towards the north and south poles by ocean water. Increased melting at the poles in the recent years is due to increased exposure of land in the tropics where the sun heats twice each year. Once on it's way from the tropic of Capricorn to the tropic of Cancer between December and June and reverses the heating effect between June and December. The sun is at the equator twice in a year (March/September) so that is where most of the heating takes place when the sun is overhead the region and the heat is distributed to the south and north poles by oceans.

In December, when the sun is overhead the tropic of Capricorn and surrounding areas, it heats solids including Deserts, lands exposed by deforestation, rocks, beaches and concrete in South America, South Africa and Australia. Because all these have a relatively lower specific heat capacity than water, they start giving off heat to the oceans which are at lower temperatures.

In February, March and April, the sun heats the equator and neighboring latitudes. Now the water that was heated from the far south while on it's way north gains a lot more heat. In June, when the sun is overhead the tropic of Cancer and its surroundings, the warmed water is also north following the sun while picking more degrees of temperature from solids in that region where the sun is overhead.

When the sun is overhead the north most latitude it can reach in the northern hemisphere, it creates an altered pressure zone in the south. This makes wind and water to change direction and start flowing southwards as the main route.

Because ocean water travels slower than the sunrays north, when sunrays turn around and start going southwards, they meet with some of the slow moving water which is already warmed. The sun provides more temperature to the water via the solids in that latitudinal region over which the sun is overhead.

By September, the sun is back to the equator heating that region twice a year as opposed to the tropic of Cancer and tropic of Capricorn regions. As a result of double heating, the equatorial region tends to warm a lot more than the regions south of the tropic of Capricorn and north of the tropic of Cancer. Also, whether the sun is in the north or south, the equatorial region still receives reasonable temperatures making it warmer than other areas. This is why we see heat concentrations around the equator. By the same token, it is at this point that most of the heat is dissipated into the oceans from the solids (exposed lands, deserts, concrete, rocks, beaches etc) due to difference in specific heat capacity.

The heat belt around the equator has intensified lately because of increased deforestation. Over the past few decades, there has been global population explosion. Rapid population increase has come with increased demand for energy, timber for construction and furniture but industrialization has not caught up to provide for energy in tropical countries. Also, there hasn't been commercial tree farming for timber exports. As a result, many large natural trees have been cut for timber export, construction and energy (charcoal/firewood) causing a deficiency in natural temperature regulation. This in turn has caused the exposed lands to emit more heat into the oceans. Reduction of large tropical trees have also led to more carbon dioxide (CO₂) in the atmosphere because trees are not enough to consume it. However, CO₂ is not the one causing ocean warming as seen with the bell experiment. CO₂ provides life to trees then trees provide us with oxygen so that we can have life. CO₂ is therefore meant to be in the atmosphere (what quantity? I don't know).

Some of the ways Carbon dioxide and Methane may get into the atmosphere.

With the suns energy, combustion of Carbon monoxide (CO) produced by automobiles, other machinery, humans and animals may fuse with oxygen (O₂) in the atmosphere to form carbon dioxide (CO₂) according to the equation 2CO+O₂→2CO₂

Similarly, with help of the sun's energy, CO may combine with Hydrogen (H) to produce a methane isotope CH₄ according to the equation 2CO+9H→2CH₄+HO₂

Both of these are considered green house gases.

Further, combustion of Methane under the sun's energy in oxygen may also give more CO₂ as shown below.

CH₄+2O₂→CO₂+2H₂O

CO₂ is also sent to the atmosphere by humans and animals as a byproduct.

These gases however, do not contribute to ocean warming as suggests the bell experiment.

Naturally, CO₂ is meant to be reduced from the atmosphere by trees but with increased production of the gas and exponential increase in tropical deforestation, there are no longer enough big trees to absorb the CO₂ in the tropics. The gas stays longer in the atmosphere as a result.

Also, CO₂ may be reduced from the atmosphere by dissolving itself in ocean water producing a diluted aqueous solution of carbonic acid as per equation H₂O+CO₂→H₂CO₃(H⁺+HCO₃). Ocean temperatures however, may affect the absorption rate of CO₂ by the oceans.

Trees in the northern hemisphere most of which without tap roots to reach out deep in the ground, are dormant for at least half of the year due to cold weather. Cold weather (autumn/winter) makes these trees drop leaves and so their participation in temperature regulation is minimal. Also, many are located in lands that are not heated so much by the sun.

Carbon dioxide is meant to be in the atmosphere to sustain life. Humans can't survive without Carbon dioxide (CO₂) in the atmosphere. CO₂ is needed by plants/trees to manufacture oxygen for life to continue on earth. Increased CO₂ is mostly a result of reduced trees. However, CO₂ has no effect on ocean temperature.

Think about it: Temperatures have lately increased around the equator where there are almost no industries more than any other place. This shows that gases such as carbon dioxide (CO₂) are not the ones elevating temperatures since CO₂ is produced most from the northern hemisphere.

It is not industrialization but deforestation that has escalated climatic change.

When the sun heats the earths surface heated objects absorbs heat basing on their composition and color. There are three types of substances that are heated by the sun on earth and these are water bodies, vegetation and other solids (Desert sand, land exposed by deforestation, rocks, concrete and beaches). These three substances behave differently in response to heat energy.

When water bodies receive heat energy from the sun, heat weakens the cohesive forces between the water molecules allowing for evaporation to take place. Water vapor from evaporation takes along with it some of the heat. In the first place, ocean water never gain much heat directly from the sun due to its high specific heat capacity and size of oceans.

When vegetation is heated by the sun, by their nature, trees and other vegetation have a mechanism for transforming heat energy into entropy of vaporization which does work to move water from the vegetation/soil to the atmosphere as per principle of conservation of energy. The water vapor condenses and is recycled into rain and dew hence cooling the earth.

When trees are cut down, the sun directly heat lands exposed by deforestation in addition to rocks, concrete, beaches and deserts. These solids don't have a mechanism for utilizing heat energy to do work and convert it to a different form so they just absorb the heat during the process. Because water has a relatively high specific heat capacity as opposed to the above solids, the solids acquires heat faster and transmits the heat to water bodies in accordance with the laws of thermodynamics. That is, the solids having acquired higher temperatures and water being at lower temperatures, plus the high temperatures just above the ground due to sunrays (daytime), a semi closed system is established and in this, heat flows only in one direction which is from hot to cold (Hot solids—Deserts, deforested lands, rocks, concrete and beaches to cold water). This heating and heat transmission process from solids to water continues everyday of the summer season as the summer travels north and south twelve months a year. Deforested lands are the ones that accounts for extra warmth in the oceans lately and not gases in space.

As the earth tilts on its axis while rotating around the sun, positioning of the sun creates temperature differences at given latitudes on earth and temperature differences creates altered pressure zones which allows ocean water to move northwards between December and June-July. Water from the southern hemisphere moves north and acquires temperature as it moves following the sun. By the time it reaches the arctic, it has enough warmth to melt snow and ice and contribute to higher water levels. On the way north, water travels slower than the sunrays causing the sun to heat the water as it moves north and heat some of it again when the sun is moving south after June.

Warmed water melts the ice/snow in the arctic resulting into sea level elevation. When sunrays reach the north most latitude they can get to (June/July), they turn around and start heading south towards the tropic of Capricorn. This heat reversal triggers change of direction of winds and water because altered pressure is now created in the southern hemisphere by the higher temperatures in the north. Warm water now heads for the Antarctic and other directions as well. Similarly, when the sun reaches the south most latitude it can get to (around December), high temperatures in the south creates an altered pressure zone in the northern hemisphere hence triggering change of direction of winds and ocean water which process takes about six months each way.

Since the sun is overhead the equator twice a year, in March and September, this region gets maximum temperatures twice a year when the sun is overhead and high temperatures for the rest of the year since sunrays and heat reaches the equator region no matter which latitude the sun is overhead.

Heat transmission from solids to water bodies can be shown by the bell experiment (reference [051]).

The Bell Experiment: A water body such as an ocean and its bordering solids are used as a large laboratory apparatus to conduct experiments that determines the rate of heat transmission from solids such as deserts, land exposed by deforestation, concrete, rocks and beaches to large water bodies.

Even if the sun heat both water and these solids at the same time, water in the oceans stays at a lower temperature because of its high specific heat capacity (reference [037]). Water then gradually gains heat through these solids.

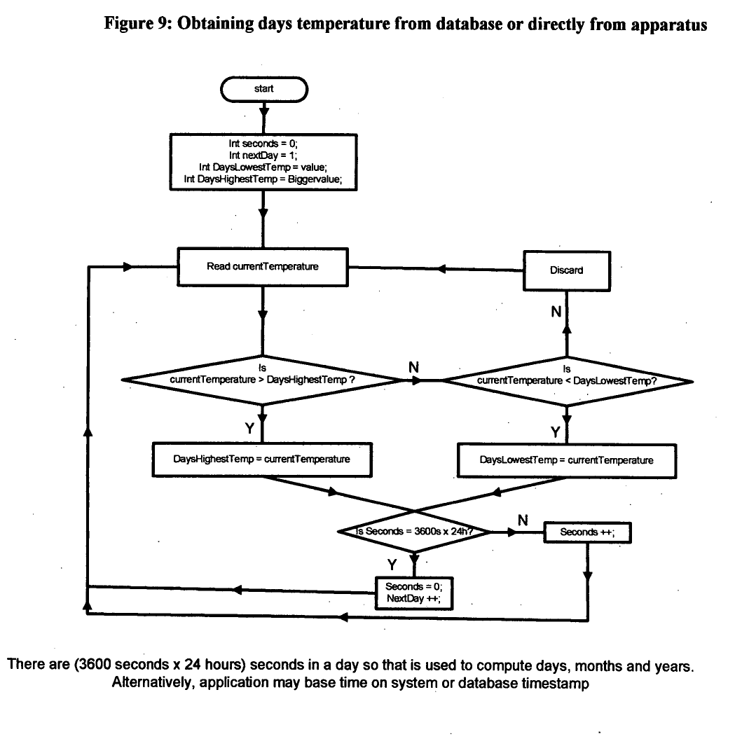

Multiple points with known distance between them and known elevations are selected along particular latitudes in relation to latitudinal position of the sun overhead those latitudes on earth. The points include inland and coastal locations all along given latitudes. Temperature data is collected along with other data and tabulated for both land and oceans. Daily highest and lowest temperatures may be computed by a software application which sets a highest and lowest to some value and comparing these to current reading value. If current reading is higher than highest, current reading becomes highest. If current reading is lower than the lowest set value, current reading becomes lowest (FIG. 9). These values are then used to get highest or lowest for a given long period of time (many days such as 30 days or 365 days). This procedure gives period of time during which atmospheric and solid temperature may have highest impact on ocean temperature.

Graphing temperature data obtained from points along particular latitudes over which the sun is overhead gives negative gradients towards the ocean showing direction of heat flow in accordance with the laws of thermodynamics. The negative gradient is caused by the relatively high specific heat capacity (reference [037]) of water in this semi closed system.

Actual experiments are carried out when the sun is overhead the areas of interest. However, control experiments may be carried out under different circumstances and areas such as concentrated tropical forests.

As heat from the solids escapes to oceans, oceans warm up and warm water moves northwards to the arctic between January and June/July. As a result, the warm oceans melt the snow/ice which lead to higher water levels in the oceans. Warm water also moves southwards between June/July and December when the sun is heating southwards. It is the sun at its peaks (vicinity of the tropic of Capricorn and tropic of cancer) that triggers change of direction of winds and water because temperatures gets elevated in the region where the sun is and creates regions of altered pressure in other places which regions acts like suction pumps and triggers winds.

Using the Atlantic ocean as the laboratory apparatus in this experiment, a deviation from expected results is encountered only on the western land block approximately between 12° North (Venezuela) and 37° North (South/North Carolina). Deviation from the norm in this region is the reason why hurricanes in the Atlantic strike that area. This can be minimized by intercepting hurricanes before they form which is achieved by controlling the factors that creates the deviations. Not all information is disclosed about this experiment.

### Operation of Apparatus

Operation: the apparatus used to collect environmental data has four different versions. One is water based and three are land based. One of the land based versions transmits data wirelessly to a satellite or wireless internet access. The second one transmits data via connected cables through the internet to servers of choice. The third version stores data internally and data is manually retrieved using removable memory. Land version of the apparatus may be powered by electricity or battery. The water version may be powered by long life batteries or any other energy source available. Solar rechargeable batteries are recommended if available.

The water based version only transmits data wirelessly via means such as satellite and others capable of real time data transmission without wires.

The second version is a land stationed apparatus that transmits data in real time using means such as satellite, internet or other. This device may be networked such that each module can listen to another and provide data to others in the vicinity and data collection center without satellite.

Third version of the device is a land based device and stores data using internal memory, removable memory or both. This third version allows data to be removed manually and taken for analysis at data collecting centers.

Every device shares data with three or more devices depending on it's location. The application that collects data is designed to acquire data only from specific devices in a group in order to limit number of devices writing to a database table or file. It identifies these devices by device ID which is continually broadcasted along with environmental data. Purpose for smaller groups is to have minimal write time. Data can then be merged from different groups into one bigger group for analysis of a larger area.

When data is transferred to the analysis server, the application on that server combines data from different groups and treats it as if it were from one group. This allows analysis of a very big area in a short time frame.

Wherever data is recorded, database tables or files are used for automated data entry. Each device may write to it's own table or multiple devices may write to the same table, file, spread sheet or data structure.

Where each device writes to its own table, the application in the device holds data transmission by means of a timer or scheduler and during that period, the application at the data collecting center merges the individual tables into one or a few tables for analysis.

Wireless version of the device continually broadcast data packets which are picked by an application server via satellite. The application filters the frames according to device ID and schedules the write processes for each device

Wired version of the device continually broadcast data packets which are picked by an application server via cables on land. The application filters the frames according to device ID and schedules the write processes for each device

Besides device ID, water temperature, atmospheric temperature, atmospheric pressure, humidity, wind speed and wind direction, device may transmits, time and date, current location (xyz coordinates), direction of device and speed of device (for the water based model) and other necessary data.

Alternatively, application may use system or database timestamp.

A GPS receiver is interfaced with a server or computer. This computer runs an application that tabulates the received data and sends it to another server or computer for analysis. After analysis, data continues to reporting servers.

Data is collected and tabulated using a database, data structures, spreadsheets or other kind of files.

In case of a database, having data in a single or fewer tables, makes comparison of data from different devices in different locations much faster.

Data from one device can also be analyzed independently since each device returns coordinates of the location as part of data.

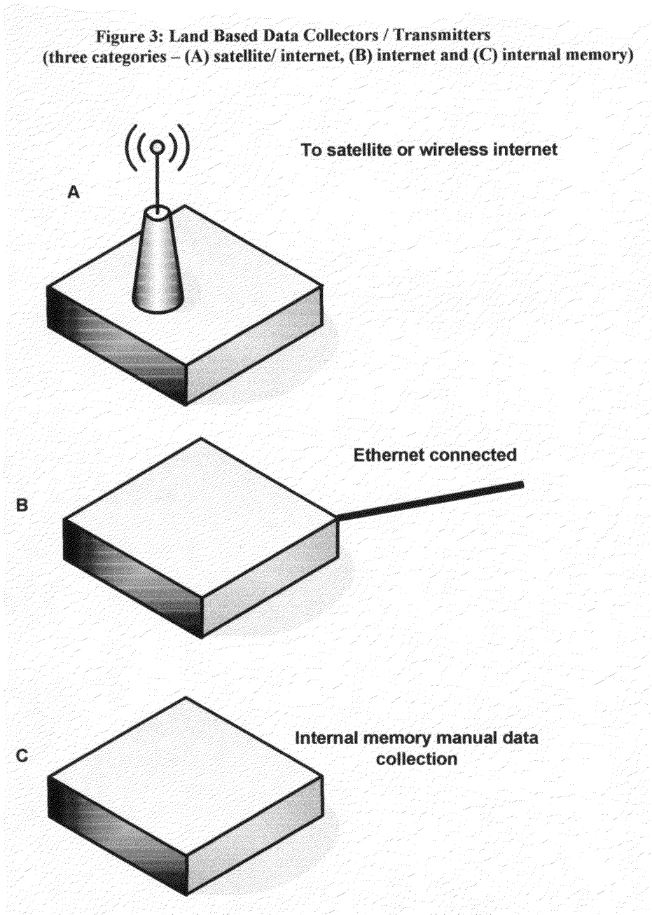

Data is transmitted to the data collecting center in real time except for the land version type C as seen in FIG. 3 where internal memory is used.

Although thermometers, barometers, hygrometers, altimeters, wind gauge, may be used to obtain temperature, pressure data, humidity data, altitude, wind speed and wind direction respectively, the device may be equipped with parameter measuring instruments of choice to digitally obtain temperature, pressure, humidity, wind speed, wind direction, and any other parameter that may be needed.

Device may be powered by solar rechargeable batteries that are recharged by the sun or any other that may deem feasible. The device is to be made water and weather proof.

The water version of the device is immersed by ships, boats or airplanes.

To determine effects of trees on temperature, pressure, wind and humidity, land version of the device may be placed in several places with different surroundings such as forests, open lands, concrete, deserts, savanna lands, inner lake areas etc.

Water based devices are likely to move so they give their location each time they transmit data.

tornadoes are formed when there is warm moist air in an area. However, for winds to move into that area, there must be altered atmospheric pressure in that area compared to places where winds move in from. Winds are triggered by altered pressure,

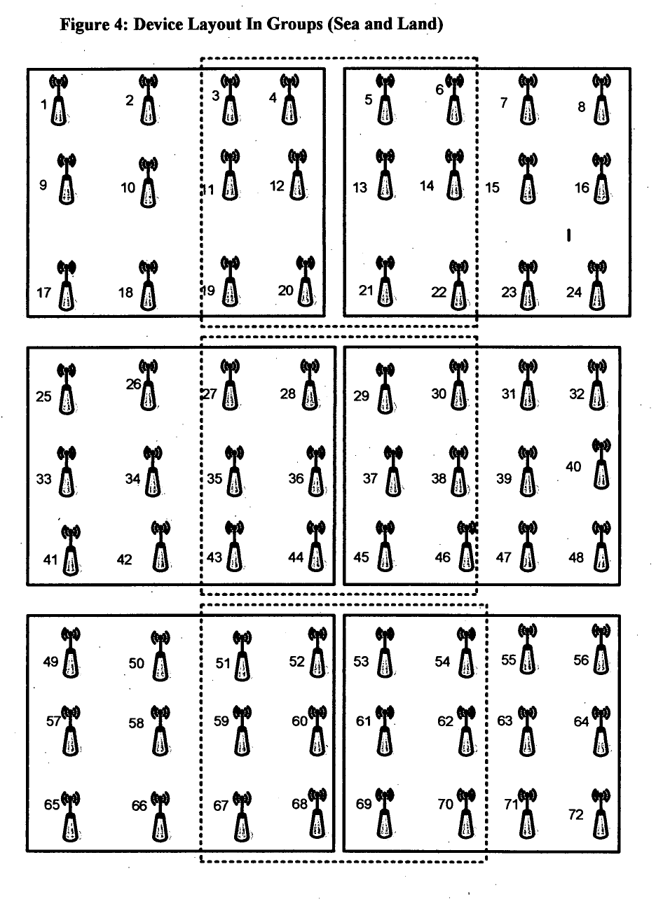

When these devices are situated in several areas at known distances between each other (FIG. 4), the devices transmits device id, location of device in terms of coordinates (X,Y,Z—where Z is elevation), direction of wind, speed of wind, humidity, and any other parameters of interest to the application.

The wind with a stronger magnitude towards altered pressure over takes the other winds since it posses a higher acceleration due to altered pressure

Combination of these winds after merging forms twisters whose direction is calculated as a resultant force.

Using speed, distance, time and direction of winds from different devices, we can tell exactly where tornadoes are to form, what time they are to form and what directions they are to take thereafter by looking at wind speed (velocity v), distance (s), centripetal acceleration (a_{c}), linear acceleration (aₗ), circumference around circular paths (c), kinetic energy (ke), all forces involved, humidity content and the correlation between temperature and atmospheric pressure in area A of wind origin and area A2 destination of winds.

A device located in a corner or at an edge of a group of devices positioned in a rectangular area (FIG. 4) shares data with at least three devices in it's vicinity. A device in the middle of other devices shares data with at least four devices on all its sides. After a device writes to a file or database and data is written to a central location, the application selects devices with consecutive locations and check for wind direction and speed.

In the application, there is a set value for wind speed that is considered to be dangerous such that when wind with such speed merges with wind from another direction, given pressure and humidity conditions, they can form a twister so the value of that wind magnitude is used as a trigger.

If the application finds that there are two or more winds from different directions but heading towards one area of altered pressure with a certain humidity level—moist air or other conditions favorable, then it determines that a land storm such as tornadoes is to form. Basing on speeds of the winds and location of initial detection, the application calculates using distance from each geometrical coordinate in that area and speed of the wind to determine where the winds are to meet and when to meet.

Since the strongest wind overpowers the other winds in a twister, the resultant force takes direction closest to that of the wind with strongest magnitude. The application uses estimated wind forces and calculates to determine final direction and force at impact of a storm when it forms.

A basic magnitude of wind speed is set in the application as a flag to which the application starts to compare wind speeds from other devices to determine direction and magnitude.

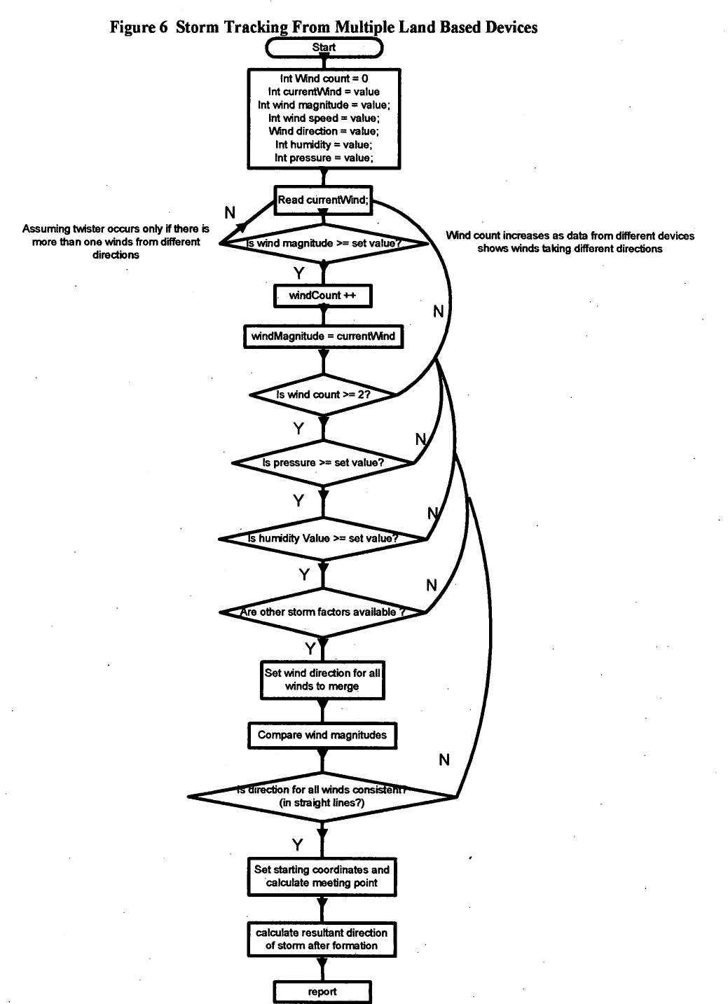

An integer variable wind count (windCount) is set to zero to show that there is no threatening wind from any direction. If wind of a high magnitude is picked by two or more devices from different directions, the application sets a flag indicating that wind is traveling in a certain direction and increases wind count by one. Similarly, all other factors favorable for storm formation are initialized as in FIG. 6.

If wind count becomes two or more, from different directions but towards the same area of altered pressure and a given humidity level, the application sets current geometrical coordinates as initial and labels that a starting point. It then uses wind speed, distance and time to calculate when and where the winds are to meet.

Device ID's are pre-programmed in the application. However, in given situations, application may have ability to take device ID's at run time as parameters.

This allows application to pick only data for a particular land storm taking place at that time. Fewer devices are used and this cuts on processing time. Application on analysis server computes time of initial land storm, actual location where it is to form from, path it is to take after formation and magnitude of storm to estimate what damages to be incurred.

Application then advise residents which direction to take during evacuation.

Using this device provides data that identifies regions where to create forest reserves.

Forests and large trees reduces the amount of heat transmitted to the oceans from the land surfaces hence reduce ocean temperatures. Reducing surface temperatures helps reduce ocean temperatures balances atmospheric pressure to normal levels and hence reduces occurrence of storms.

### Additional Embodiment

Hypothesis 1 There is a kind of acceleration (Acceleration due to altered pressure) that drives winds and storms. This acceleration over powers centripetal acceleration during storms and creates a driving force towards direction of altered pressure. Collecting data from several points in a straight line in the direction of wind on a water or land surface at the same altitude, helps determine whether acceleration due to altered pressure is a constant or a variable. Data for this purpose includes at least wind direction, distance between points of interest, wind speed and pressure at each of the points included. A very light flat objects may be placed on water near each of the data transmitting devices and released to sail on water to other points at known distances and pressure in order to estimate speed of ocean water under the given conditions. Knowing whether this acceleration is constant or variable is important in dealing with storms in general.

Hypothesis 2 Storms are driven by acceleration due to altered pressure. As the earth rotates around the sun, sun rays are projected on earth with light and heat in specified areas along a few latitudes at a time. Sunrays continually shift between the tropic of Capricorn and tropic of cancer and their vicinity. This makes the sunny season move south and north causing different weather conditions in affected regions. The north/south movement of the sunny season (summer) along with heat, creates temperature differences in the different north/south regions. Change in surface temperature leads to change in atmospheric pressure. Altered atmospheric pressure causes air movement or winds in the direction of altered atmospheric pressure.

When the sun is at the north most latitude it gets to (June/July), it creates altered pressure in the southern hemisphere hence triggering wind and water direction to change towards the south. Similarly when sunrays reach the south most latitude they can get to around December, the southern region is subjected to higher temperatures that creates altered pressure in the northern hemisphere triggering change of direction of winds and water towards the north. Difference in pressure in the regions around the equator causes some of the wind and water to divert east and west but most of it heads north.

Around March and September when the sun is over head the equator, some tropical regions experience mini changes of wind direction.

Heat from the sun loosens the cohesive bonds between water molecules making them more susceptible to displacement by winds.

As the earth tilts on its axis, movement of wind on warmed water surfaces causes water to move as storms in the direction of winds and altered pressure. The warmer the water, the easier for it to move in large quantities since warm water is less dense than cold water. Route or path of storms such as hurricanes, is determined by atmospheric pressure between the point of storm origin and point of destination while intensity is mostly due to water temperature and the driving force which driving force is a byproduct of pressure.

Altered pressure provides a kind of acceleration that allows air to move as winds. It is this acceleration that determines magnitude of the driving force of a storm.

Without other factors, wind travels in a straight line between two areas at different pressures. When other factors come into play, forces moving in opposite directions are created but pulled to a common point and end up causing circular motion which results into a storm.

When pressure difference between two areas is high enough, acceleration due to altered pressure overpowers centripetal acceleration that comes with the storms causing winds or storms in circular motion to travel horizontally towards altered pressure.

Colder water and slightly balanced pressure offers some resistance and this slows down a water based storm. Similarly, balanced atmospheric pressure terminates a storm.

If a storm gets created then surface pressure balances out or becomes uniform over the entire area of the storm given there is no moving water, the storm may stand still without horizontal movement but with only circular motion. Because there is no altered pressure, here acceleration due to altered pressure is zero so force in the horizontal direction is F=ma (F=M×0=0).

For hurricanes in the Atlantic Ocean, water acquires heat starting from the tropic of Capricorn and vicinity around December and continues to receive heat as it travels northwards gathering heat from surrounding deserts, beaches, rocks and open lands which dissipate heat into the ocean. Water warmed all the way from the tropic of Capricorn travels slightly slower than sunrays (summer season) northwards while acquiring more heat. That is why hurricanes tend to start around June.

Hurricanes in the Atlantic are more frequent than those in the pacific because the Atlantic is narrower. As water moves from the south to the northern Atlantic, the Atlantic receives more heat from the Namibi desert, Patagonian desert, the Sahara desert, beaches and rocks in addition to the bare lands due to deforestation in Africa and South America.

In general, when the sun is over head the tropic of Capricorn in December, it heats bare lands rocks and deserts in South America, South Africa and Australia. These warm up so much during daytime. Because these solids and powders have a lower specific heat capacity than water in water bodies, they try to establish thermal equilibrium making water warmer each day as the sun shifts position towards the tropic of cancer.

At the same time, the relatively warm water also moves northwards along with the sun while picking more degrees of warmth from the surrounding bare surfaces.

If two areas A1 with original pressure P1 and A2 with altered pressure P2 happens to be physically connected and A1 happen to have a storm, the storm will be directed to area A2 as long as A2 is the one with the most altered pressure compared to other areas around.

Altered pressure P2 triggers winds in the direction of area A2. The winds provides a driving force F=ma where m is the mass of winds/water and “a” is the acceleration due to altered pressure. Area A2 with altered pressure acts like a vacuum or suction pump. The acceleration may be constant or a variable. If pressure in area A2 suddenly equals pressure in area A1, the storm may not have a resultant force to drive it horizontally so can stop moving and just circle around only with centripetal, gravitational and centrifugal forces or totally calm down.

In November 2006, NASA produced a picture of what they thought was a stationed storm at Saturn's South Pole and said they had no explanation why it wasn't moving. I think it was stationary because there was no near by area with altered pressure so there was uniform pressure in the entire region where the storm was located. This lead to the driving force F=ma=0 because acceleration due to altered pressure was zero. Meaning no motion in horizontal direction could take place.

Hypothesis 3—hurricanes: Storms such as hurricanes in the Atlantic and Pacific Oceans started occurring after formation of deserts in the southern hemisphere. Desert effects fuels the storms and deforestation in the equatorial region accelerates the storms.

Storms can be greatly reduced in intensity or completely eradicated by determining regions that need creation of forest reserves and creating those reserves. Forest reserves in Africa and South America helps cool those regions and balance atmospheric pressure by transforming heat from the sun into entropy of vaporization which does work to create tropical rains. This prevents over warming of oceans and hence reduce formation of hurricanes. Vicinity of deserts in Africa and South America may be regions of interest but data determines.

Data obtained simultaneously in real time with all parameters gives accurate record and hence better conclusions.

Hypothesis 4 floods: Vaporization of water bodies in the presence of strong winds due to temperature and pressure differences leads to displacement of water from original locations to areas where the winds blows. This may cause heavy rainfall in places where the rain wouldn't have fallen and may cause floods in those areas. It is the cause for water level drops in inland lakes that experience heavy sunshine. When trees around lakes are cut down, the sun directly heats exposed lands. Because the exposed soil and rocks have lower specific heat capacities than water, they absorb heat faster and transfers the heat to lakes causing massive evaporation. Example: Evaporation of Lake Victoria in Uganda-Kenya and Tanzania may cause floods in Somalia or elsewhere far from that region.

Hypothesis 5 Trees: Trees cool the environment by using heat energy from the sun to recycle water. Trees also absorb carbon dioxide produced by machinery, humans and animals and produce oxygen to sustain life. Automobiles produce Carbon monoxide (CO) which fuses with oxygen (O) in the atmosphere forming carbon dioxide (CO2). As winds blow to directions of slightly altered (normal) pressure due to temperature differences, carbon dioxide is absorbed by trees. Trees then give off oxygen and other useful substances that clean the atmosphere. Once trees are cut down, the cycle is broken and this result into warming of the exposed earth.

Hypothesis 6 Trees continued: Availability of trees reduce surface temperatures and hence regulates atmospheric pressure. Large leafy tropical trees with tap roots that penetrate deep into the earth sucks water solutions with chemicals which chemicals are given off along with Oxygen as byproducts.

Trees in the northern hemisphere, loose leaves for more than half of the year so they barely participate in the overall temperature regulation since they are not fully active during the period of (autumn/winter). It is the tropical trees that play a major roll in replenishing the environment by absorbing CO2 and regulating temperature since they are alive twelve months a year.

Whatever happens to the atmosphere or ozone layer as a result of industrialization can be repaired by planting trees (forest reserves) in the right places. Damages by deforestation are unfixable.

Creation of forest reserves in identified areas of the tropics reduces effects of the sun by covering exposed lands and some desert areas. This prevents direct heat to the ground and hence prevents heat that would be transmitted into water bodies. Vegetation is heated instead. Heating of vegetation leads to evapotranspiration which in turn leads to rains and dew hence cooling the earth.

When the earth is cooled, temperature and pressure are balanced to normal levels. Both water and land based storms can be eliminated or greatly reduced.

Hypothesis 7: Reduction in surface and hence ocean temperatures is only achieved by creating forest reserves in specific regions in the tropics. These regions can be identified by collecting data in the Atlantic, pacific and Indian oceans close to Africa, South America, Australia and south Asian countries near the equator as well as from the continents of Africa, South America, Australia and some parts of southern Asia.

Moving top soil to some deserts, creating forest reserves and irrigating them in those deserts can completely eradicate Atlantic storms.

Hypothesis 8: Collecting and tabulating data for atmospheric pressure (Pₐ) and atmospheric temperature (Tₐ) over time in different environments tells whether atmospheric pressure is directly or inversely proportional to atmospheric temperature. Data is collected from area A₁ at temperature T₁ and another area A₂ at temperature T₂. Assuming that Pₐ α cTₐ (where the coefficient c=1/α², c=1 or c=a constant k).

When c=1 in the equation Pₐ α cTₐ, it means altered pressure is directly proportional to temperature. That is, temperature increases or decreases in the same proportions with pressure.

When c=1/α², it implies that altered atmospheric pressure is inversely proportional to Temperature. That is, the higher the atmospheric temperature in any of the regions A₁ or A₂, the lower the pressure in those regions.

Values of wind direction and wind speed in conjunction with temperature and pressure values can tell effects of temperature on pressure and effects of pressure on winds.

Collecting data on winds and land storms knowing that they have forces of magnitude F=ma where m is approximate mass of high speed air per cubic volume and “a” is acceleration due to altered pressure, it can be deduced that acceleration due to altered pressure is a constant or a variable whose magnitude is determined by surface factors such as frictional forces or not.

Getting wind speed at the initial point (X₁,Y₁,Z₁) of detection of winds of a given magnitude to a point (X₂,Y₂,Z₂) of storm formation, then from initial point of storm formation (X₂,Y₂,Z₂) to final point where storm dies off (X₃,Y₃,Z₃), distance (S) covered by both winds and storms is found and time (t) to cover that distance is also obtained. Taking wind speed as velocity (v), values of the acceleration due to altered pressure can be calculated using the equations of motion. This hypothesis helps in the study of both water and land based storms.

### Prediction

If forest reserves are not created in areas of interest all tropical lands that is, whole of Africa, northern South America, Austria and southern Asia will become deserts. As a result, the northern hemisphere will be heavily flooded.

Before this happens, some parts including northern South America will be flooded heavily due to displaced rains as the inland lakes in Africa and South America will be drying out. People in Africa, South America, South Asia and Australia may die due to luck of food.

Hurricanes in the Atlantic will intensify more than they've ever been experienced and may start storming South America mainland before it becomes a desert. After south America becomes a desert, hurricanes will head straight for the eastern United States Canada and Europe. At this point hurricanes may not strike the Gulf of Mexico. Water will become a lot warmer and all the snow/ice at the north and south poles will melt elevating water level in the oceans. This will result into submersion of all low coastal and inland regions.

Possible Solutions to Deter Deteriorating Climate (Recommendations)
(1) Creation of forest reserves in identified areas in the tropics can greatly replenish the degrading environment and cool down the oceans. However, most affected regions depend on trees for energy and timber.
(2) An alternative energy source such as electricity eliminates the need for charcoal and firewood as sources of energy in tropical countries. Clean energy such as solar may be considered due to the fact that this region has abundant sunshine.
(3) Building solar power plants on massive scale in these regions will bring down the cost of solar panels and promote environmental conservation hence protect the ecosystem.
(4) While developing power stations and power lines, underground cabling and metallic poles may be substituted for wooden electric poles which requires cutting of trees.
(5) Use of computers in office environments eliminates need for paper. Use of computers and email saves trees, save money in the long run and makes information retrieval much easier.
(6) Wherever possible, plastic and metal should be used instead of wood.
(7) Large scale production of trees purposely for commercial timber production saves the natural trees which takes many years to grow but are cut down in just hours. Tree farming for timber/lumber will help spare the natural trees to regulate global weather conditions.
(8) G 8 countries currently provide financial aid to tropical countries for mosquito nets. That money can be redirected to create solar power plants so that inhabitants of those regions can leave the natural trees intact. Instead of purchasing nets, the affected countries may emphasize proactive sanitary methods such as eradication of water lodged conditions that allows breeding of mosquitoes near their homes. This prevents mosquitoes.

### CONCLUSION

Device helps to show that oceans are warmed by heat transmitted to them from exposed solids on earth when the sun is overhead those solids/semi solids. Device also helps in the study of water and land based storms and advises on how the two can be reduced or eliminated to save lives and reduce property damage.

I) An apparatus used to collect multiple environmental data variables including temperature, pressure, wind speed, wind direction, humidity and coordinates of the location of the apparatus to permit analysis of forces of nature and energy in water bodies in relation to time and space.

II) Said device in (I) floats on water and collects atmospheric temperature as well as water temperature at multiple depths of a given location in a three dimensional plane.

III) Said device in (I), transmits collected data in real time via means such as satellite, internet, and any other that delivers data instantaneously to a data collection location.

IV) Said device in (I), transmits after confirming by means of software that data collected is equal to or better than required preset value such as highest or lowest temperature of a day.

V) A data collecting apparatus to be positioned on a land surface at locations of interest, to collect multiple data parameters including temperature, pressure, wind speed, wind direction, humidity and location of apparatus in terms of geometric coordinates.

VI) Apparatus set forth in claim (V), is deployed in groups where data from one device is combined with data from other devices to determine conditions at two or more different locations at the same time hence predicting possible storm conditions at other locations in direction of wind in relation to altered pressure, humidity and other storm factors.

VII) Said device in (V) transmits data via satellite, via internet or other method capable of real time data delivery.

VIII) Transmitted data from said device in (V) is used to pinpoint location where land based storms such as tornadoes are to form and direction they are to take hence eliminating need for human storm chasers and leading to forecasting of storms that occur at night or during daytime before the storms occur.

IX) An apparatus wherein networked wirelessly or with cables listens to other devices directly or indirectly via a software application and provides environmental data in relation to the next device in the vicinity.

XI) Said device in (IX), provides data to an application directly or indirectly and the application triggers warnings that gets to residents electronic devices such as cell phones, personal digital assistants, computers and others providing them with storm information.

XII) Said device in (IX) provides data to an application directly or indirectly which application triggers sirens in areas to be affected.

XIII) A data collecting device that does not transmit data but provides environmental data manually by means of internal memory, removable memory or both.

XIV) A device used to collect data which data is used to find relationships between two or more of the parameters temperature, pressure, wind speed, wind direction, humidity in relation to a specified location and latitudinal position of the sun.

XV) A mechanism (bell experiment) for collecting and analyzing environmental data basing on latitudinal position of the sun to determine rate of heat transmission from earthly solids such as lands exposed by deforestation, deserts, beaches, concrete and rocks to large water bodies.

XVI) Said mechanism in (XV) allows choosing of points on land, in water or both land and water along latitudes with exposed land over which the sun is overhead and tabulate the data including temperature values.

XVII) Control experiments are carried out in accordance with claim (XV) in other locations with concentrated forests which forests provides canopy to land and reduces solid/water heat transmission rates.
